(19) United States
(12) Patent Application Publication
(10) Pub. No.: US 2026/0067266 A1
(43) Pub. Date: Mar. 5, 2026

(54) SYSTEM AND METHOD FOR SECURE PASSWORDLESS LOGIN USING ORIGIN HEADER IDENTIFICATION

(71) Applicant: Jason Ira Rubenstein, Milford, CT (US)

(72) Inventor: Jason Ira Rubenstein, Milford, CT (US)

(21) Appl. No.: 19/259,538

(22) Filed: Jul. 3, 2025

Related U.S. Application Data
(60) Provisional application No. 63/688,689, filed on Aug. 29, 2024.

(51) Int. Cl. H04L 9/40

(52) U.S. Cl. CPC H04L 63/0807; H04L 63/105

(57) ABSTRACT

The disclosed technology is embodiments of a method using passwordless login with the use of an origin header, which requires less setup for integration on a website. The method includes an element that the callback URL will always be the original request origin at the start of the flow. Also disclosed is a system including computing components to execute a method of passwordless login with the use of an origin header.

### REFERENCE TO RELATED APPLICATIONS

This application claims the benefit of U.S. Provisional Patent Application No. 63/688,689, entitled, “SYSTEM AND METHOD FOR SECURE PASSWORDLESS LOGIN USING ORIGIN HEADER IDENTIFICATION,” filed on Aug. 29, 2024, the content of which is hereby incorporated by reference herein in its entirety.

### BACKGROUND OF THE INVENTION

User authentication has historically been a more difficult than average component of web technology to implement independently. Companies would rely on libraries and frameworks and eventually with the rapid growth of Service Oriented Architecture (SOA), external services Specific SOA patterns for external authentication are Open Authorization (OAuth), OpenID Connect, and Security Assertion Markup Language (SAML). While there is a lot of overlap between different authentication standards, the nuances between them provide each of them their unique tradeoffs.

The most natural and basic form of authentication is username and password based. While some external authentication providers, or identity providers (IDPs) ask for a username and password to indirectly authenticate, this is not always the case. If a service is password based, they will often allow for a second factor to be configured, such as sending a short code to a phone number or integrating a two factor short code application. A more modern and now more established technique of authentication removes the need for a password altogether, using a similar two factor approach without the original password. Passwordless login takes advantage of message inboxes only a single authorized user would legitimately have access control over, or a hardware input such as biometric sensor that identifies a single person in a secure way, such as a fingerprint reader or hardware authentication key.

Since passwordless login does not require a user created password, it can be considered more secure. It also becomes easier for customers to access services without the extra step of account creation, which in many cases is just the password creation step. Some businesses will choose to implement their own passwordless solution, while others will leverage a third party IDP. An IDP can provide a business with passwordless, username/password, and single sign on (SSO) solutions all in one place, but often requires significant work to integrate with their service and site. A novel approach is to provide businesses with the same level of convenience passwordless login provides to their customers. Passwordless login requires no account creation, and unlike traditional IDPs, which usually require some sort of account setup to use their interface, a novel approach would not. Additional benefits of passwordless login to customers are some level of anonymity, depending on the user identifier provided, the line between account sign up and subsequent logins are blurred, and the overall hastening of the authentication process and flow. A novel approach would provide these same three benefits to the business themselves when integrating with an IDP on behalf of the users.

### DESCRIPTION

By being able to securely leverage the HTTP origin header, sent along with requests from a site loaded into any legitimate modern browser, the disclosed embodiments of the technology can fully and securely identify the target for any generated authentication token. From the perspective of the novel IDP being described within, there is no difference between the first call a business ever makes to their service and any subsequent. There is no separate initial step. A side benefit of the design is that the IDP becomes self service, and businesses can leverage the IDP service, without sharing more beyond their origin, or the origin portion of their website URL. The origin portion of a website url consists of the scheme, such as https://the domain, and the port, if not the default of 80 for http requests. It can also be asserted that overriding the passed origin does not break the design, in fact this can be accounted for by its implementation. The user is notified by message what business they are authenticating for, and a unique token is only targeted for that business, and can be verifiably only sent to that business.

### BRIEF DESCRIPTION OF DRAWINGS

FIG. 1 is a diagram of the steps of an embodiment of the method.

FIG. 2 is a flow diagram of the initial steps of an embodiment the method before the difference between embodiments of the code sub flow and link sub flow.

FIG. 3 is a flow diagram of an embodiment of the differing steps for code sub flow, in a code based authentication method.

FIG. 4 is a flow diagram of an embodiment of the differing steps for link sub flow, in a link based authentication method.

FIG. 5 is a flow diagram of an embodiment of the final steps of the method after the differing steps of either code sub flow or link sub flow.

FIG. 6 is a diagram of an embodiment of a computing component.

FIG. 7 is a diagram of an embodiment of a host.

FIG. 8A is a diagram of an embodiment of the connection between computing components and a host to execute the method of passwordless login.

FIG. 8B is a diagram of an embodiment of the connection between computing components, of at least a first and second computing component, to execute the method of passwordless login.

FIG. 9 is a diagram of an embodiment of software.

FIG. 10 is a diagram of an embodiment of a website and interactions of the business entity customer and the business entity with the website.

FIG. 11 is a diagram of an embodiment of an interstitial page.

FIG. 12 is a diagram of an embodiment of a physical location of an IP address and an IP address.

FIG. 13 is a diagram of an embodiment of an email message.

FIG. 14 is a diagram of an embodiment of an email message.

FIG. 15 is a diagram of an embodiment of the method with a link.

FIG. 16 is a diagram of an embodiment of the method with a code.

FIG. 17 is a diagram of variations in embodiments of the method of passwordless login.

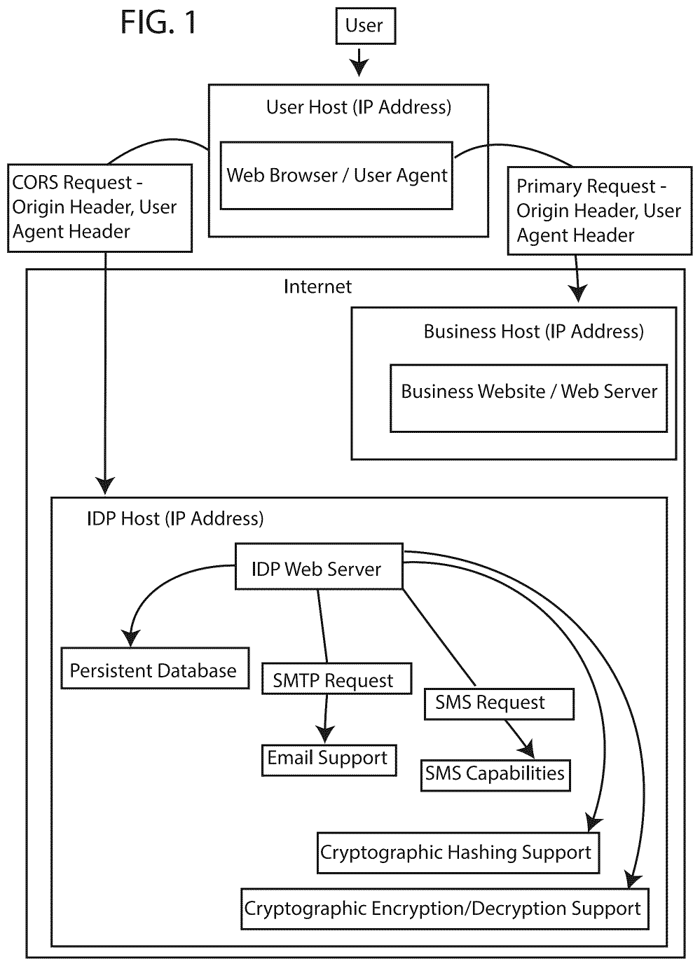

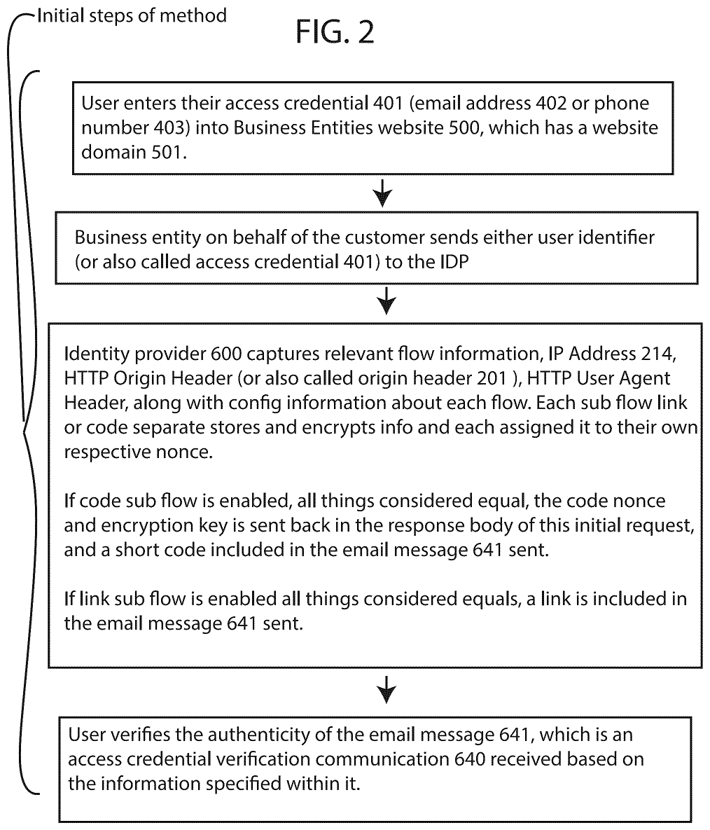

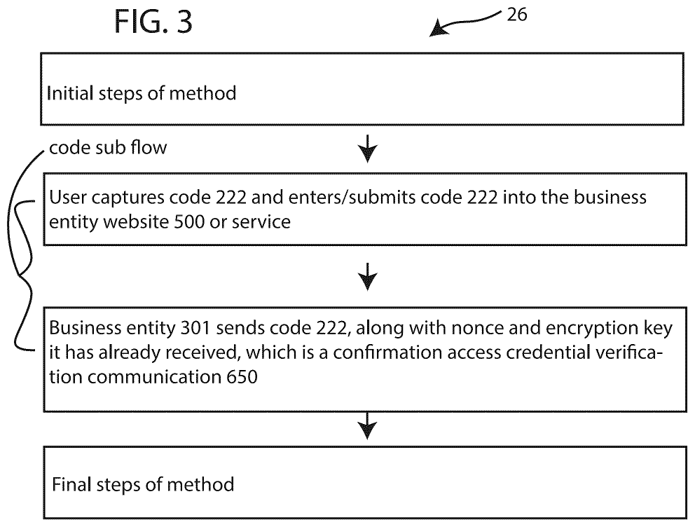

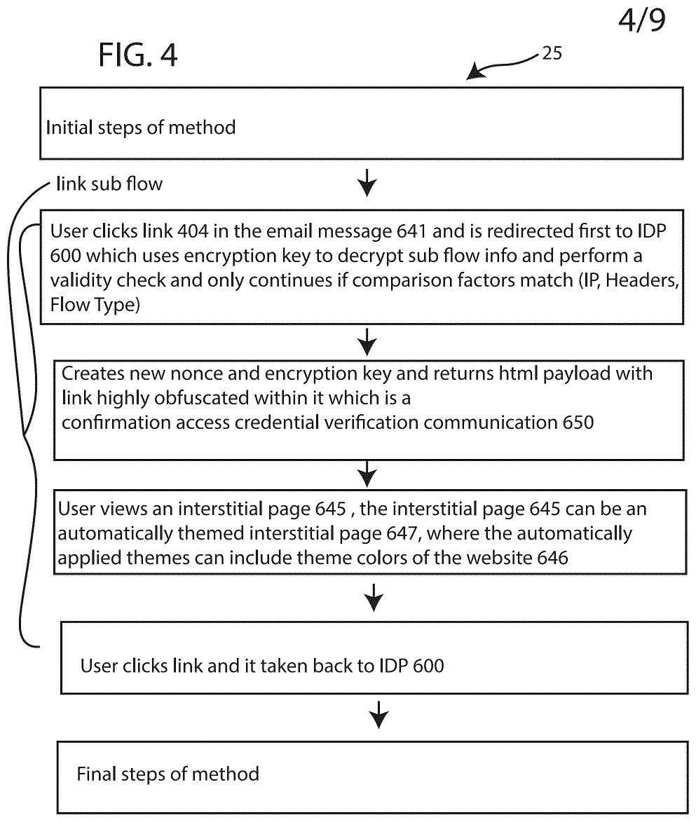

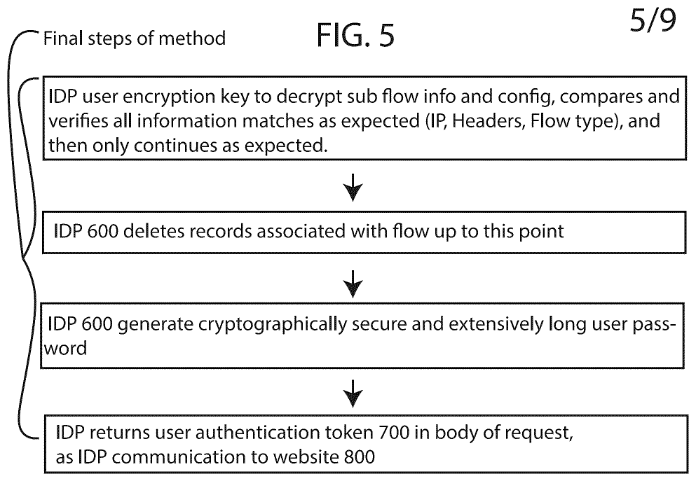

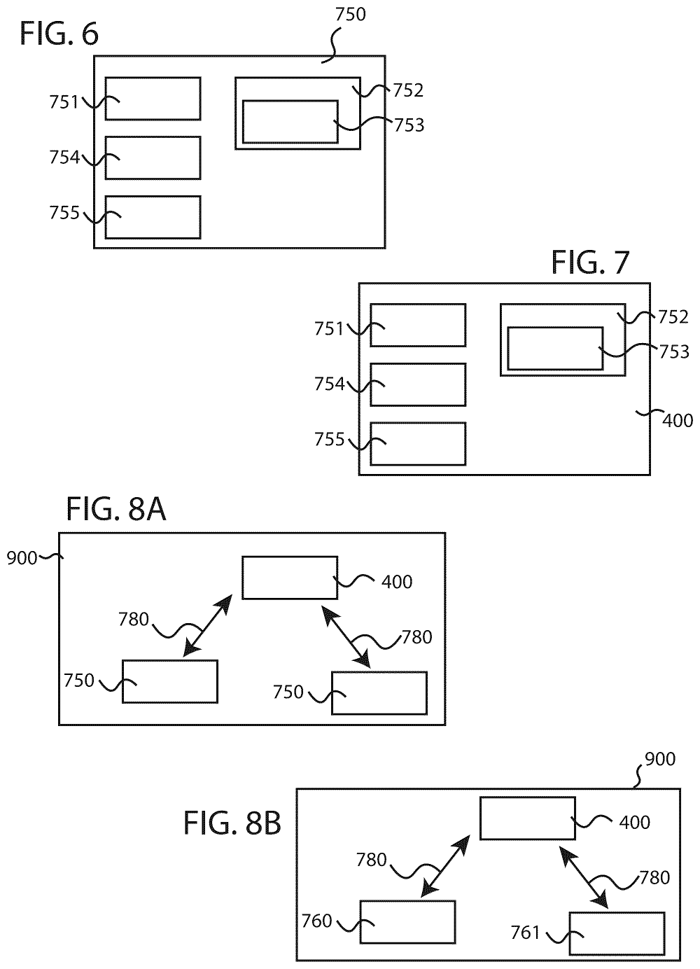

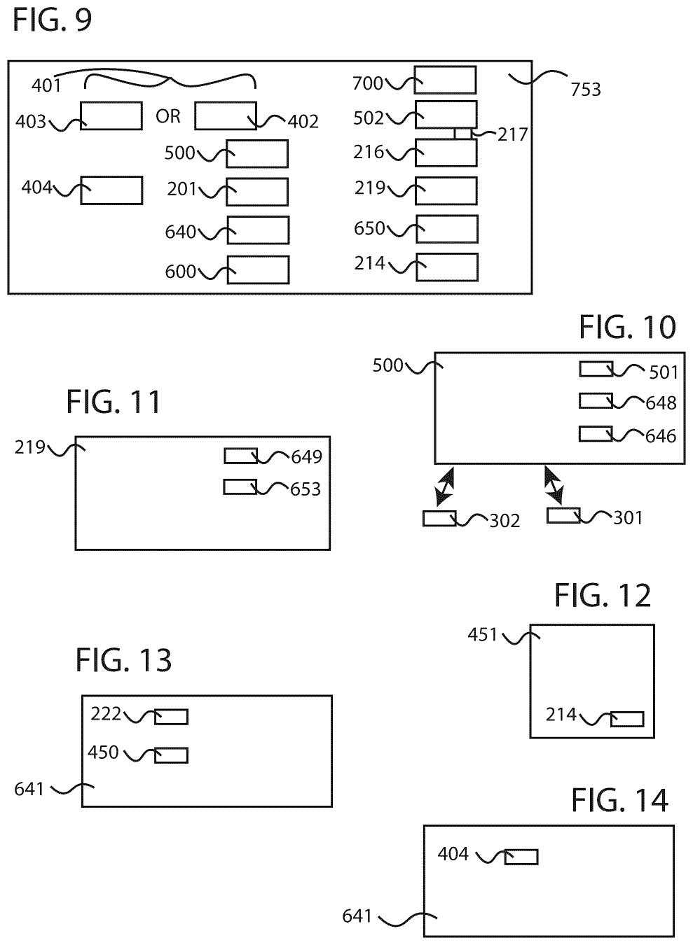

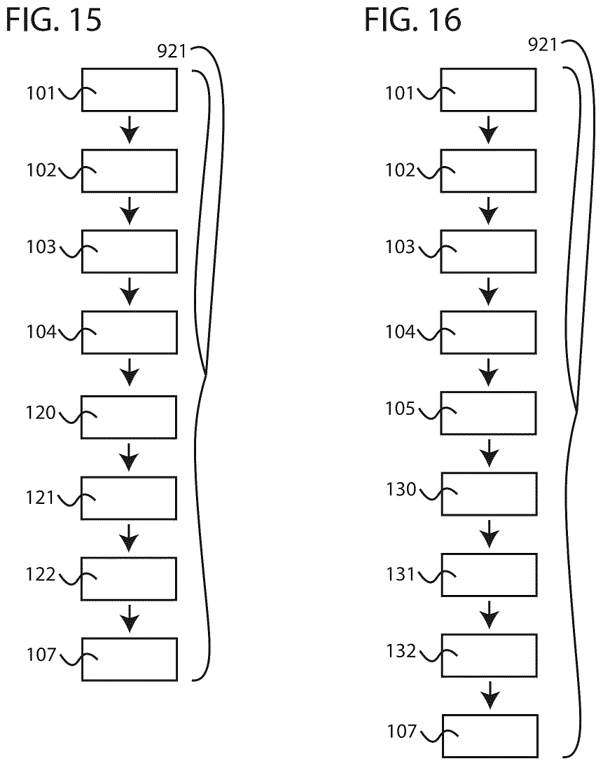

### DETAILED DESCRIPTION OF THE INVENTION

There are two main actors involved in this novel authentication flow. A business entity 301, and a business entity customer 302. A third implicit actor is the design itself. While the business entity 301 has a direct relationship with the identity provider, also called IDP 600, the business entity customer 302 has an indirect one, communicating with the IDP 600, only by means of the business entity 301, and via the integration the business entity 301 has provided to be used on behalf of itself to the business entity customer 302.

The business entity customer 302 can also be called a Business Customer.

A business entity 301 will begin integrating with the aforementioned IDP 600, by presenting a customer or user with the ability to enter an authentication credential, which can be an email address 402, phone number 403, or some future secure message inbox resource identifier. An authentication credential can also be called an access credential 401. A customer can be called a business entity customer 302 or user. An API library may be provided to assist in invoking the api at any point, but is not inherently necessary and merely a convenience to the business entity 301, to expedite setup and/or clarify the necessary input parameters for each stage of the API flow.

The API and login flow being considered for novelty here, always begin with the same API call, and for all subsequent logins in the same way. A business entity 301 will invoke this API path, providing the user identifier, or also called access credential 401, they have previously collected from the user (email address 402, phone number 403) and some additional configuration such as which sub login flows or methods to enable, providing constraints on the succeeding flow that happens directly between the business entity customer 302 and the IDP 600. The business entity customer 302 is on a web browser 502 and enters their access credential 401, such as an email address 402 or phone number 403, into the website 500 of the business entity 301. The user index identifier, and any configuration selections are passed to the API by setting the appropriate HTTP content header value matching the encoding of the payload, and appending the body of the HTTP request. It is essential, not trivial, that this information is sent in the body, ensuring the passed values, especially the business entity customer's email address 402 or phone number 403 are not cached by intermediary systems or proxies.

It is also essential to point out how Cross Origin Resource Sharing 226 relates to the use of the HTTP origin header or also called origin header 201. Cross Origin Resource Sharing 226 can be abbreviated as CORS. The motivation behind CORS is to create boundaries around resources accessed across origins. For instance, it would be unsafe if one site could load the contents of another transparently and modify it without providing any indication to the user that this has happened. It is an optimistic security technique, since it can be bypassed, but in many ways protects everyone. Using a legitimate modern browser like CHROME™ is safer, because it enforces this standard alongside almost every modern browser available today. The HTTP origin header, origin header 201, is not easily spoonable in normal web browser or user agent scenarios, and implicitly sent along with every HTTP request to a third party origin, such as website A on origin A, calling an API found at origin B.

Other implicitly sent headers, include the user agent header 216, which contains a string uniquely defining the user agent or web browser 502 making the request, the IP address 214 (also called the User IP Address) albeit at a lower layer of the HTTP protocol, below the application layer, and other such unrelated information. The IP address 214 and user agent header 216 deserve special mention here, because they are an essential part of this description. The user agent header 216 can also be called a HTTP User Agent Header.

In embodiments of the technology the web browser defines the user agent header 217.

The business entity 301 will construct a request which is then forwarded to the underlying operating system and unto more granular transport layers, one of which packages the source ip address along with the request. The request is then transferred over the internet, and reaches the destination host, or host 400 implementing the novel IDP 600 described within, as the destination address. The destination host must be generally available, have adequate resources to run the necessary software modules and features, and have access to a persistent datastore 204 to manage persistent, yet short lived information. The persistent datastore 204 supports clustering.

The host 400 itself must have enough memory to run a modern http framework and http server, but any http framework 208 will be compatible, as long as it can receive HTTP bodies, and map URL paths to specific handlers. The http framework 208 can also be called a HTTP server framework. The HTTP server required, can be implemented in any computing language, as long as it adheres to the features inherently necessary to make the design work. It is important to distinguish between a host 400 and server 190, where the host 400 is the physical or virtual device receiving the incoming network request, and the server 190 is the software which the request is forwarded to be listening on a specific port.

The HTTP publicly accessible web server that supports clustering 192 can be a server 190 or host 400. The server 190 or host 400 are two separate things. The server 190 is software. The host 400 is the machine it runs on. The terms of server 190 and host 400 are often loosely used interchangeably.

The server 190 must also have access to a highly available database. There must be some sort of method for creating and removing data, and in between those two operations the database records must remain untouched and consistent. The database should also support encryption at rest, even though the individual personally identifiable information will be individually encrypted with unique keys only sent to the user each time. The individual personally identifiable information can also be called individual personally identifiable information 225, User PII, or PII.

All of the package information sent in the body of this first request, is first serialized then encrypted, then persisted. The key is never stored, and the encrypted information is keyed in the database by the nonce that is also cryptographically random and only sent back to the business entity customer 302. Inside the database itself, only a hash of the nonce is stored, and only hashes of emails are ever stored.

The server 190 itself must be adequately performant to support hashing at a fast enough rate to make the whole design viable, but any modern server should handle this with enough ease. The number of nonces and encryption keys generated, increases and correlates with the number of sub flows enabled. Each sub flow is isolated to prevent exploiting one through combined use of the other. The email message 641 or SMS message 180 (access credential verification communication 640) will contain information for continuing further with one or more sub login flows, and it is assumed only one person and only the intended person has access to their own email inbox or phone. It can also be assumed that in almost any case, if a malicious actor gains access to the business entity customer's email inbox or full access to the business entity customer's device, that the business entity customer's identity has been compromised. This novel implementation intends to be an improvement beyond and just as good as or more, then existing solutions, not inherently flawless. There are tradeoffs in designing a system.

Third party SMS integration can be a SMS message 180 or SMS inbox 181.

The initial login flow endpoint does not need to be fast, it happens once during an attempted flow, and will have an individual rate limit set on it. All endpoints in this design will have rate limits, but by comparison this one will be expected to execute less often per source ip address and for a longer timespan due to the nature of operations it must perform.

As part of this initial call, the endpoint can fetch and choose to persist additional metadata about the origin. This additional metadata, could include branding theme colors heuristically pulled from the origin resources' configuration or page. This allows for self service branding and theming, helping to make this an anonymous service for both user and the businesses, while still having the service blending with their own aesthetic. The website 500 of the business entity 301 has theme colors of the website 646 or aesthetic qualities of the website 648.

A brief note about monetizing. This design can support paywalls, and still provide anonymous access for paid users. By allowing anonymous payment methods such as crypto for instance, and acknowledging emails accounts can also be anonymous. A payment can be tied to an email upon submission of payment, and then a hash of that email is copied into TXT DNS record assigned to that origin. Asymmetric encryption can be another option considered for the future, to increase privacy and avoid using hashed information in public DNS records.

Also what makes this implementation uniquely novel and possible, is the outcome, but that outcome is achieved by removing configuration possibilities that other IDPs regularly allow. For instance, several IDPs allow the callback URL or the destination the browser is redirected to in some cases containing the authorization token 700 to be fully specified. This service has standardized the callback URL will always be the original request origin at the start of the flow, plus some standardized path for convenience. The request origin is the website domain 501. The authorization token 700 can only be sent to the website domain 501. The fixed callback URL can also be called the callback URL 211. By locking down features like this, the origin header 201 can completely be relied upon to securely identify business entity 301 using the identity provider 600 for the purpose of authenticating a business entity customer 302 using the website 500 of the business entity 301. The whole entire flow only respects the original origin header 201 passed in, as well as the original IP address 214 and user agent header 216. They must match these initial values respectively for the remainder of the flow. In rare and coincidental cases a requesting user's IP address 214 will change mid flow, but due to the rare nature of this happening, it is not being considered a fault in the design. Additionally, certain dynamic proxies, such as APPLE ICLOUD™ relay, which randomly change the ip address between every request, will not be able to use this service to its full potential, although any standard privacy proxy would be able to. A warning can be displayed indicating the reduced security form using a proxy like ICLOUD™ relay, and a user can continue at their own risk. By randomly changing a user's IP address, it opens up the possibility of a man in the middle attack when using the code sub flow, although very rare. In the access credential verification communication 640 sent to the users inbox, all information is made clear, the IP address of the original request, which should match their current IP address, the geographical location of the request, the origin through the request was made, as well as additional links and suggestion to help confirm their continued action is secure.

An access credential verification communication 640 is a communication sent so the business entity customer 302 can view the access credential verification communication 640 and then the access credential verification communication 640 can be verified to indicate whether the access credential 401 was wanted to be entered into the website 500 by the business entity customer 302. A confirmation access credential verification communication 650 is a communication sent to indicate that the business entity customer 302 can verify, or confirm, that the business entity customer 302 access credential 401 was entered by the business entity customer 302 into the website 500, or in other words wanted to be entered into the website 500.

The following is documented so that the entire flow can be understood as a unit, even in the case of a reference implementation. It has already been asserted that the crux or significance portion of this design is that the origin header 201 can be used on its own to determine the business and target for any generated authentication token 700, and what allows for this is the locking down of certain configuration parameter that ensure a link redirect style login flow can still be secure. At one point, someone thought that just relying on emails for passwordless login made sense, and this is the same step forward in regards to password login. Continuing on with the two sub flows, there was capture of the necessary user credential during the initial flow api request, the rest of the flow is essentially read only. Nonces and encryptions keys will be regenerated for the second stage of the link sub flow, but they happen automatically and by the server only. A code will be entered in order to verify a user's identity, but this will only be used for comparing the inserted value and the stored value. During the final stage of the auth flow or handshake, and key will be persisted, and this occurs at the end of both sub flows, but again this is automatic and by the server only. This write once, read every subsequent time approach ensures whoever initiated the login, whether legitimately or not, any information sent in the login email will continue to be true. The Internet Protocol (IP) address, if determined to be valid, will be checked during every stage to make sure it hasn't shifted. The target for the token remains the same and so on. There is a clear point of reference. Once the message is sent to the business entity customer's inbox, either a phone number or sms inbox 181, they are presented with the amiable methods to login depending on the number configuration that was first passed during the initial login flow API call.

Starting with the first sub flow, which called the Link Flow (LF) within, a user will visibly see a link 404 (in an access credential verification communication 640) and decide to click that link 404 to continue with authentication. The link 404 contains a nonce and an encryption key in the path. This encryption has only been sent to this email address 402. It is not stored in the server, in either memory or on disk. By clicking the login link, and thus sending a confirmation access credential verification communication 650, they are providing the server the ability to decrypt the ephemeral identity information only there to enforce a safe and secure login.

An embodiment of the link flow method can be described as having the element of clicking the link is verifying the access credential verification communication to indicate the access credential was wanted to be entered into the website 920. A clicking of the link is equivalent to an activation of the link, such as tapping of the link on a touch screen, or activation in some other form.

An embodiment of the link flow method includes a link 404.

Their personal info is first decrypted, read and checked to be valid, then a new nonce and encryption key are created, and both are returned embedded inside a highly obfuscated JavaScript script inlined into a html response payload. The new nonce and new encryption key are used to generate a second link navigating to the next step of the flow.

The interstitial page 219 can be stylized to match the customer business site or product by making requests against the origin during the initial api call. It hasn't been asserted yet, but the login widget a business presents to customers through their site can look however the business requires. In the future, and only due to limited resources while building the reference implementation, businesses can anonymously configure dns records so the IDP server can send email from any sub domain on their behalf. This IDP design only consists of a platform API, and site for marketing reasons, to make the concept more clear. The idea is that any site can transparently use this service and it immediately blends in with the rest of the site or product. On this interstitial page 219 which a user sees, they have the option to click login with website domain 501 that represents the business that made the original login request on behalf of the user. Once clicking login with website domain 501 the embedded link will take them back to the server, perform the same checks as the original link in the email and redirect them back to the origin with an authentication token 700 in the url. The authentication token 700 is simply an astronomically long cryptographically random password. Somewhere between 256 to 512 characters in length. It uses letters, upper and lower, numbers, and every symbol. There can be variations in the form of the authentication token 700. The authentication token 700 is URL encoded to ensure it can travel back to the browser in the redirect reliably in all cases. Currently the web browser 502 or business entity customer 302 is redirected with the hash in the fragment portion of the URL. This is best practice for a flow where the link is intended to be received by the web browser 502. Since the hash fragment part of URL is never sent to the web servers, even if passed while making a request while using any legitimate modern web browser, it prevents some forms of accidental or intentional misuse of the authentication token 700.

The interstitial page 219 can also be called a Link Flow interstitial page.

The interstitial page 219 involved in an embodiment can be also described as follows. There are aesthetic qualities of the interstitial page 649. There is a step of determining the aesthetic qualities of the website 651. There is a step of making the aesthetic qualities of the interstitial page the same as the aesthetic qualities of the website 655.

The interstitial page 219 involved in an embodiment can be also described as follows. There are theme colors of the interstitial page 653. There is a step of determining the theme colors of the website 652. There is a step of making the theme colors of the interstitial page the same as the theme colors of the website 654.

The code flow completely overlaps even in behind the scene api calls, except for the extra interstitial step the link flow performs. The final auth call that the interstitial page 219 calls, also accepts a code flow nonce 223, and encryption key. It passes both plus the option code to this endpoint, and does the same redirect with a token. An embodiment of the short code is 12 characters long and contains upper, lower, numerical and symbols as well. The short code can also be called a code 222. The code 222 can also be called Code Flow Code. Variations in the form of the code 222 are possible.

Every slice of data self deletes after some number of seconds has passed. Auth tokens or on demand passwords are automatically deleted by the data store using triggers every 7 days. The temporary user info that is stored to secure the login and used for comparison only lasts for 5-10 minutes. Since the link sub flow has two stages, 5 minutes for the first stage, and another 5 mins after the data is re-encrypted for the second stage.

This description above describes at length the most important parts of this design, while also providing much context for the rest of the design. To summarize, an element of the novelty of this invention is how the origin header 201 alone can be used to identify the target for the authentication token 700. The target asserts which business can use this authentication token 700 to verify this user has logged in with them. This feature blurs the lines for a business using this api for the first time and every subsequent time, similar to how passwordless login blurs the line between logging in and between account creation but in this case for the business as well.

The business entity customer 302 gains access to the login method through a computing component 750.

An embodiment of the computing component 750 comprises a processing component 751, a storage component 752, user interface component 754, and communication interface component 755. There can be variations in the form of the computing component 750, such as a lack of a user interface component 754, depending on the computing component 750.

The processing component 751 executes software 753. The software 753 is stored on the storage component 752.

The processing component 751 may be a processor, more than one processor, a microprocessor, a mobile processor, graphics processing unit, or other similar technology.

The storage component 752 may be non-transitory computer readable medium, such as a solid state drive, a hard drive, peripheral storage, cloud storage, or other storage.

The software 753 may be instructions, instructions translatable by the processor, or other similar technology.

A user interface component 754 allows the business entity customer 302 to enter input or receive output from the computing component 750. The user interface component 754 may have elements of a keyboard, mouse, microphone, touchscreen, or other similar technology to enter input. The user interface component 754 may have elements of a display, speakers, or other similar technology to provide output.

A communication interface component 755 is an element to connect the computing component 750 to other computing components 750 or hardware. The communication interface component 755 may be a network interface card, antenna, or other similar technology.

A network communication 780 connects the computing component 750 to the host 400. The network communication 780 is communication connections such as the internet, mobile network, WAN, LAN, or other similar technology.

The login method allows for the steps to occur of the link-based authentication method 25 or code-based authentication method 26. The login method is executed on a hardware execution system 900 of a computing component 750 and a host 400, or multiple computing components 750 and a host 400, or multiple computing components 750 and multiple hosts 400, or multiple computing components 750. The hardware execution system 900 can also be called a system. Embodiments of the method are executed on a system.

An embodiment of a host 400 can have a processing component 751, a storage component 752, and communication interface component 755, and may also have a user interface component 754 in some instances. As such a host can be considered a type of computing component. There can be variations in the form of the host 400.

An embodiment of the technology can be: a system can be composed of, and the method can be executed on, at least two components of a first computing component 760 and a second computing component 761.

An overview of the method steps can include a description of the initial steps before the differences in the code sub flow and the link sub flow; then either a sub flow of a code sub flow or a link sub flow; and then final steps.

The initial steps of the method can be described as: 1) business entity customer 302 enters their access credential 401 of an email address 402 or phone number 403 into Business Entities website (website 500); 2) business entity 301 on behalf of the business entity customer 302 sends the access credential 401 to the IDP 600; 3) IDP 600 captures relevant flow information, IP address 214, origin header 201, user agent header 216, along with config information about each flow. Each sub flow link or code separate stores and encrypts info and each assigned it to their own respective nonce, where if code sub flow is enabled, all things considered equal, the code nonce and encryption key is sent back in the response body of this initial request, and a short code included in the email message 641 (access credential verification communication 640) sent, and where if link sub flow is enabled all things considered equal, a link is included in the email message 641 (access credential verification communication 640) sent; and 4) User verifies the authenticity of the email received based on the information specified within it, with a confirmation access credential verification communication 650 is sent.

The code sub flow can be described as: 1) business entity customer 302 captures the code 222 from the access credential verification communication 640 and enters/submits code 222 into the website 500; and 2) Business entity sends code 222, along with nonce and encryption key it has already received as a confirmation access credential verification communication 650.

The link sub flow can be described as: 1) business entity customer 302 clicks link in an email message 641, where the email message 641 is an access credential verification communication 640, and there is a redirect first to the IDP 600 which uses encryption key to decrypt sub flow info and perform a validity check and only continues if comparison factors match (IP address 214, Headers, such as origin header 201 and user agent header 216, Flow Type); 2) Creates new nonce and encryption key and returns html payload with link highly obfuscated within it; 3) business entity customer 302 views automatically themed interstitial page 647; and 3) automatically themed interstitial page 647 clicks link so a confirmation access credential verification communication 650 can be sent and then the flow is taken back to IDP 600.

The final steps can be described as: 1) IDP user encryption key to decrypt sub flow info and config, compares and verifies all information matches as expected (IP address 214, Headers, such as origin header 201 and agent header 216, and Flow type), and then only continues as expected; 2) IDP 600 deletes records associated with flow up to this point; 3) IDP 600 generate cryptographically secure and extensively long user password; and 4) IDP 600 returns authentication token 700 in body of request.

When there are references to HTTP, that can be replaced with HTTPs.

An email message 641 sent to the business entity customer 302 can include an image of a map 450, or in other words an image of a map 450 is viewable in the access credential verification communication 640. There is a physical location of the IP address 451 where the business entity customer 302 performed the entering of an access credential into the website 910. The image of the map depicts the physical location of the IP address 452.

In embodiments of the technology, the actions within the steps of the method can be called processes.

An embodiment of the method can be additionally described to include a step of, entering the access credential into the website occurs from an IP address 918.

An element of an embodiment of the method can include a step of, entering the access credential into the website occurs through a web browser 911.

Elements of an embodiment of the method can include the following steps. There is a website use of the identity provider for passwordless login into the website 921. There is a quality of an account setup is not required for the website use of the identity provider for passwordless login into the website 927. There is a step of, sending an origin header to an identity provider 912. There is a step of, sending an access credential to the identity provider 913. There is a step of, sending an access credential verification communication to be verified to indicate whether the access credential was wanted to be entered into the website 914. There is a step of, sending a confirmation access credential verification communication to the identity provider 915. There is a step of, sending an authentication token to the website 916. In the step of sending an authentication token to the website 916, the authentication token can only be sent to the website domain, the origin header is identification of an allowable destination for the authentication token 928.

An embodiment of the method can include: verifying the access credential verification communication to indicate the access credential was wanted to be entered into the website 922.

An embodiment of the method can include: the identity provider only needs the website domain as a prerequisite for the website use of the identity provider for passwordless login into the website 923.

An embodiment of the code flow method can be described as having the element of entering the code into the website is verifying the access credential verification communication to indicate the access credential was wanted to be entered into the website 917

An embodiment of the method can include elements of: the authentication token can only be sent to the web browser, the web browser is identification of an allowable destination for the authentication token 925; and the authentication token can only be sent to the web browser, the user agent header is identification of an allowable destination for the authentication token 926.

An embodiment of the method can in include: authentication token can only be sent to the IP address, the IP address is identification of an allowable destination for the authentication token 924.

The identification of the website use of the identity provider for passwordless login into the website 921 can be included in any of the drawings which describes an embodiment of a method of passwordless login of the website 500 using the IDP 600 for passwordless login into the website 500.

When a request is made from the web browser 502, to trigger the email message 641, every request also has a response. The email going out is a side effect that happens when the request reaches the IDP 600, the response is sent back to the web browser 502 where it was made from.

Responses can also contain data. In this case, if and only if the code flow is enabled, the response contains similar data to the information in the link, but not identical in value, just the same type and purpose, and only usable in combination with the code 222 inside the email message 641. The link 404 works without the code 222.

Both the email message 641 with the link 404 and code 222, and the response having data, can happen with that first single request to the IDP 600, they are not mutually exclusive, but the request's response will only contain data when code flow is enabled, since it's only used for that flow. The email message 641 also only includes a code 222 if code flow is enabled.

When a business entity customer 302 enters the code 222, from the email message 641, into the website 500, the webpage javascript code takes responsibility for keeping the response from that first request to the IDP 600, the one that triggered the email message 641, temporarily in memory. That response information is then subsequently sent back with the code 222, once it's manually entered into the website 500.

An embodiment of the method can be described as having the following steps:
Business integrates IDP implementation with their online business presentation 101;
User access IDP implementation API by submitting their email or phone number;
through the online business presentation, which is then forwarded to the IDP API 102;
Business forwards user information to the API, which implicitly includes the HTTP origin header (containing the URL Origin), user's ip address, user's user agent string (such as which browser and version this is), user email or phone number, supported flows (link and code) 103;
IDP receives input listening on secure HTTP port, parses JSON request body, and extracts values, encrypts PII without persisting encryption key, stores encrypted version, creates and persists nonce with encrypted data, sends email or sms with link and/or code info depending on requested flow support 104;
Link redirects user to interstitial page with new nonce and encryption key embedded inside 120;
Checks are performed such as ip matching and user agent matching before even reading the interstitial page call to action, otherwise CTA is not rendered an error message is presented instead 121;
User clicks CTA and is redirection to website with either auth token, or error message in hash of URL 122; and
Business/site service now has auth token, validates using the IDP token is currently valid and can either branch off with their own session management or check auth token repeatedly. Session management is encouraged preventing unnecessary calls and controlling timed logouts independent of IDP 107.

An embodiment of the method can be described as having the following steps:
Business integrates IDP implementation with their online business presentation 101;
User access IDP implementation API by submitting their email or phone number through the online business presentation, which is then forwarded to the IDP API 102;
Business forwards user information to the API, which implicitly includes the HTTP origin header (containing the URL Origin), user's ip address, user's user agent string (such as which browser and version this is), user email or phone number, supported flows (link and code) 103;
IDP receives input listening on secure HTTP port, parses JSON request body, and extracts values, encrypts PII without persisting encryption key, stores encrypted version, creates and persists nonce with encrypted data, sends email or sms with link and/or code info depending on requested flow support 104;
If code flow support is enabled, api returns additional nonce and key to the browser 105;
Users enters code in browser 130;
When code is entered uses separation nonce and encryption key 131;
Token is sent as response back to the browser. Users are encouraged to make sure ip addresses match and geolocation of IP matches their expectations before entering the code 132; and
Business/site service now has auth token, validates using the IDP token is currently valid and can either branch off with their own session management or check auth token repeatedly. Session management is encouraged preventing unnecessary calls and controlling timed logouts independent of IDP 107.

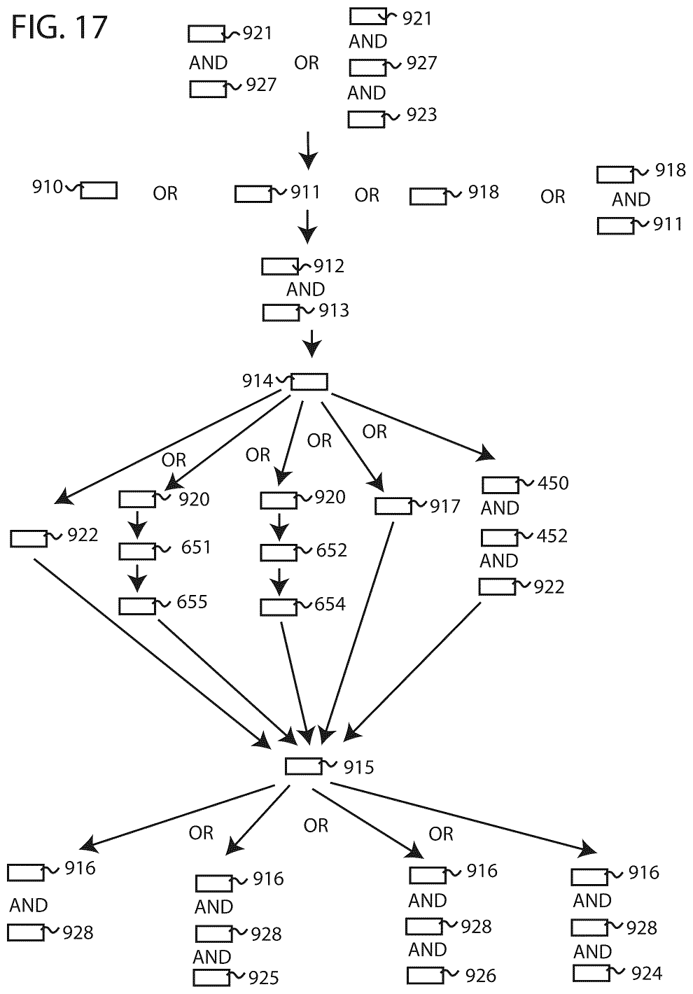

An embodiment of the method can be viewed in FIG. 17 where there can be other steps in between the pictured elements.

Elements of other embodiments of the method and/or apparatus can include: a) HTTP authentication header, “authentication header”; b) internet capable user agent capable of rendering HTML, CSS, and executing JS, adheres to web standards, “modern browser” or “user agent”; c) cryptographic library, “cryptographic”; d) hashing library, “hashing”; e) SMTP server process capable of routing email securely, “email server” or “SMTP”; f) random long cryptographically secure PW token, “auth token” or “cryptographically random password”; g) PW Token TTL, “automatically deleted by the data store using triggers”; h) User Agent, “user agent”; i) Link Nonce (1), “nonce”; j) Link Nonce (2), “new nonce”; k) Link Encryption Key (1), “encryption key”; I) Link Encryption Key (2), “new encryption key”; m) Code Flow Encryption Key, “code flow encryption key”; n) IDP customer key or client API key, “client API key”; o) HTTP content type header, “HTTP content header”; p) IP Address, “source IP address”.

Further, components in the described embodiments can be described as:
link-based authentication method 25
code-based authentication method 26
SMS message 180
SMS inbox 181
server 190
HTTP publicly accessible web server that supports clustering 192
origin header 201
persistent datastore 204
http framework 208
callback URL 211
IP address 214
user agent header 216
web browser defines the user agent header 217
interstitial page 219
code 222
code flow nonce 223
personally identifiable information 225
Cross Origin Resource Sharing 226
business entity 301
business entity customer 302
host 400
access credential 401
email address 402
phone number 403
link 404
image of a map 450
physical location of the IP address 451
image of the map depicts the physical location of the IP address 452
website 500
website domain 501
web browser 502
IDP 600
access credential verification communication 640
email message 641
theme colors of the website 646
automatically themed interstitial page 647
aesthetic qualities of the website 648
aesthetic qualities of the interstitial page 649
confirmation access credential verification communication 650
determining the aesthetic qualities of the website 651
determining the theme colors of the website 652
theme colors of the interstitial page 653
making theme colors of the interstitial page the same as the theme colors of the website 654
making aesthetic qualities of the interstitial page the same as the aesthetic qualities of the website 655
authentication token 700
computing component 750
processing component 751
storage component 752
software 753
user interface component 754
communication interface component 755
first computing component 760
second computing component 761
network communication 780
IDP communication to website 800
hardware execution system 900
entering an access credential into the website 910
entering an access credential into the website occurs through a web browser 911
sending an origin header to an identity provider 912
sending an access credential to the identity provider 913
sending an access credential verification communication to be verified to indicate
whether the access credential was wanted to be entered into the website 914
sending a confirmation access credential verification communication to the identity provider 915
sending an authentication token to the website 916
entering the code into the website is verifying the access credential verification
communication to indicate the access credential was wanted to be entered into the website 917 entering the access credential into the website occurs from an IP address 918
clicking the link is verifying the access credential verification communication to indicate
the access credential was wanted to be entered into the website 920
website use of the identity provider for passwordless login into the website 921
verifying the access credential verification communication to indicate the access credential was wanted to be entered into the website 922
identity provider only needs the website domain as a prerequisite for the website use of the identity provider for passwordless login into the website 923
authentication token can only be sent to the IP address, the IP address is identification of an allowable destination for the authentication token 924
authentication token can only be sent to the web browser, the web browser is identification of an allowable destination for the authentication token 925
authentication token can only be sent to the web browser, the user agent header is identification of an allowable destination for the authentication token 926
account setup is not required for the website use of the identity provider for passwordless login into the website 927
authentication token can only be sent to the website domain, the origin header is identification of an allowable destination for the authentication token 928

The present invention is not limited to the above described embodiments. The above described embodiments are merely illustrative and other variations and modifications may be possible without departing from the scope of the present invention.

1. A system comprising:
at least two computing components, each computing component comprising:
a processor;
instructions; and
a non-transitory computer readable medium;
the system is configured for a website use of an identity provider for passwordless login into a website, an account setup is not required for the website use of the identity provider for passwordless login into the website, the website has a website domain;
the system is configured where upon entering an access credential into the website, the instructions are executed by some or all of the processors to perform processes comprising:
sending an origin header to the identity provider, the website domain defines the origin header;
sending the access credential to the identity provider; and
sending an access credential verification communication to be verified to indicate whether the access credential was wanted to be entered into the website; and
the system is configured where upon verifying the access credential verification communication to indicate the access credential was wanted to be entered into the website, the instructions are executed by some or all of the processors to perform processes comprising:
sending a confirmation access credential verification communication to the identity provider; and
sending an authentication token to the website, the authentication token can only be sent to the website domain, the origin header is identification of an allowable destination for the authentication token.

2. The system of claim 1,
the identity provider only needs the website domain as a prerequisite for the website
use of the identity provider for passwordless login into the website.

3. The system of claim 1, further comprising:
the entering the access credential into the website occurs from an IP address; and
the authentication token can only be sent to the IP address, the IP address is identification of an allowable destination for the authentication token.

4. The system of claim 1, further comprising:
the entering the access credential into the website occurs through a web browser; and
the authentication token can only be sent to the web browser, the web browser is identification of an allowable destination for the authentication token.

5. The system of claim 1, further comprising:
the entering the access credential into the website occurs through a web browser;
the web browser defines a user agent header; and
the authentication token can only be sent to the web browser, the user agent header is identification of an allowable destination for the authentication token.

6. The system of claim 2, further comprising:
a link is viewable in the access credential verification communication, the access credential verification communication is an email message; and
the system is configured where clicking the link is verifying the access credential verification communication to indicate the access credential was wanted to be entered into the website.

7. The system of claim 6, further comprising:
determining aesthetic qualities of the website; and
making aesthetic qualities of an interstitial page the same as the aesthetic qualities of the website.

8. The system of claim 6, further comprising:
determining theme colors of the website; and
making theme colors of an interstitial page the same as the theme colors of the website.

9. The system of claim 2, further comprising:
a code is viewable in the access credential verification communication, the access credential verification communication is an email message; and
the system is configured where entering the code into the website is verifying the access credential verification communication to indicate the access credential was wanted to be entered into the website.

10. The system of claim 2, further comprising:
an image of a map is viewable in the access credential verification communication, the access credential verification communication is an email message;
an IP address;
a physical location of the IP address;
the image of the map depicts the physical location of the IP address; and
the entering the access credential into the website occurs from the IP address.

11. A method, at least some of the method is performed by a computing component, the method comprising:
the method is configured for a website use of an identity provider for passwordless login into a website, an account setup is not required for the website use of the identity provider for passwordless login into the website, the website has a website domain;
entering an access credential into the website;
sending an origin header to the identity provider, the website domain defines the origin header;
sending the access credential to the identity provider;
sending an access credential verification communication to be verified to indicate whether the access credential was wanted to be entered into the website;
upon verifying the access credential verification communication to indicate the access credential was wanted to be entered into the website, sending a confirmation access credential verification communication to the identity provider; and
upon verifying the access credential verification communication to indicate the access credential was wanted to be entered into the website, sending an authentication token to the website, the authentication token can only be sent to the website domain, the origin header is identification of an allowable destination for the authentication token.

12. The method of claim 11,
the identity provider only needs the website domain as a prerequisite for the website use of the identity provider for passwordless login into the website.

13. The method of claim 11, further comprising:
the entering the access credential into the website occurs from an IP address; and
the authentication token can only be sent to the IP address, the IP address is identification of an allowable destination for the authentication token.

14. The method of claim 11, further comprising:
the entering the access credential into the website occurs through a web browser; and
the authentication token can only be sent to the web browser, the web browser is identification of an allowable destination for the authentication token.

15. The method of claim 11, further comprising:
the entering the access credential into the website occurs through a web browser;
the web browser defines a user agent header; and
the authentication token can only be sent to the web browser, the user agent header is identification of an allowable destination for the authentication token.

16. The method of claim 12, further comprising:
a link is viewable in the access credential verification communication, the access credential verification communication is an email message; and
clicking the link is verifying the access credential verification communication to indicate the access credential was wanted to be entered into the website.

17. The method of claim 16, further comprising:
determining aesthetic qualities of the website; and
making aesthetic qualities of an interstitial page the same as the aesthetic qualities of the website.

18. The method of claim 16, further comprising:
determining theme colors of the website; and
making theme colors of an interstitial page the same as the theme colors of the website.

19. The method of claim 12, further comprising:
a code is viewable in the access credential verification communication, the access credential verification communication is an email message; and
entering the code into the website is verifying the access credential verification communication to indicate the access credential was wanted to be entered into the website.

20. The method of claim 12, further comprising:
an image of a map is viewable in the access credential verification communication, the access credential verification communication is an email message;
an IP address;
a physical location of the IP address;
the image of the map depicts the physical location of the IP address; and
the entering the access credential into the website occurs from the IP address.
